(19) United States
(12) Patent Application Publication
(10) Pub. No.: US 2016/0163292 A1
(43) Pub. Date: Jun. 9, 2016

(54) Accessories for Instruments with Soundholes

(71) Applicant: Stanley Landis, Burbank, IL (US)

(72) Inventor: Stanley Landis, Burbank, IL (US)

(21) Appl. No.: 14/561,587

(22) Filed: Dec. 5, 2014

(51) Int. Cl. G10D 3/00

(52) U.S. Cl. CPC G10D 3/00

(57) ABSTRACT

A guitar accessory item may act to prevent items such as guitar picks from falling into the body of a guitar through its soundhole. The accessory may include a body portion that may be ring-shaped. The body portion may act as a base to which one or more fasteners and a mesh netting may be attached. The body may be flexible to enhance ease of installing the accessory in/about the soundhole of the guitar. The fasteners may be C-shaped clips or similar fasteners that secure the accessory to the guitar. The mesh netting may be may cover a gap defined by the body portion.

### BACKGROUND OF THE INVENTION

1. Technical Field

The present application relates to accessories for stringed instruments and more specifically, for guitars.

2. Related Art

Guitarists enjoy a love/hate relationship with their picks—they love the feeling they get when playing with that perfect pick but hate the fact they are often losing their grip on it. When that pick does get away, the force applied by the tension of the strings can cause the pick to fly in chaotic fashion. The problem is even worse for acoustic guitar players, as the string tension and action of an acoustic guitar is typically high. As a result, runaway picks often fly directly into the soundhole of the guitar. Once inside, the picks can get stuck on the geometry inside the guitar cavity and can be difficult to retrieve. During live performances, this problem can literally be show stopping if another pick is not at the ready, and the runaway pick can still clank around inside the guitar, distracting the guitarist and/or creating inadvertent noise.

Currently, there are devices that fit within a soundhole of an instruments that may block some or all of the soundhole. For example, suppressor devices are designed to alter the sound emanating from the soundhole. Guitarists often place one or more pickups in or about the soundhole of an acoustic instrument. A pickup is a transducer that captures mechanical vibrations from stringed instruments and converts them to an electrical signal that can be amplified, recorded, or the like. Because the sound waves emanating from the soundhole may also be “picked up” by the pickup, feedback can occur. To reduce or eliminate feedback, the guitarist may use a suppressor device to suppress the sound emanating from the soundhole. The suppressor devices are usually made of thick rubber, and while they may also help to prevent items from falling into the soundhole, the sound altering properties of these products are not always desirable.

In another example, decorative soundhole covers are available for concealing speakers and electronic controls contained with the cavity of a guitar. However, these products require an elaborate installation process and many guitarist do not need or want the electronics products these covers are meant to conceal.

Accordingly, a need has long existed for an improved guitar accessory item.

### SUMMARY

In one embodiment, a guitar accessory item may act to prevent items such as guitar picks from falling into the body of a guitar through its soundhole. The accessory may include a body portion that may be ring-shaped. The body portion may act as a base to which one or more fasteners and a mesh netting may be attached. The body may be flexible to enhance ease of installing the accessory in/about the soundhole of the guitar. The fasteners may be C-shaped clips or similar fasteners that secure the accessory to the guitar. The mesh netting may be may cover a gap defined by the body portion.

Other systems, methods, features and advantages of the invention will be, or will become apparent to one with skill in the art upon examination of the following figures and detailed description. It is intended that all such additional systems, methods, features and technical advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention.

FIG. 1 shows an elevated view of an exemplary guitar accessory;

FIG. 2 shows a side view of an exemplary guitar accessory;

FIG. 3 shows an elevated view of a guitar equipped with an exemplary guitar accessory;

FIG. 4 shows an elevated view of another guitar accessory;

FIGS. 5a and 5b show side views of the exemplary guitar accessory shown in FIG. 4; and

FIG. 6 shows an elevated view of a guitar equipped with the exemplary guitar accessory shown in FIG. 4.

### DETAILED DESCRIPTION OF THE PREFERRED EMBODIMENTS

The elements illustrated in the Figures interoperate as explained in more detail below. Before setting forth the detailed explanation, however, it is noted that all of the discussion below, regardless of the particular implementation being described, is exemplary in nature, rather than limiting. For example, although several embodiments are described concerning an accessory for use with a guitar, accessories may also be provided for use with other instruments.

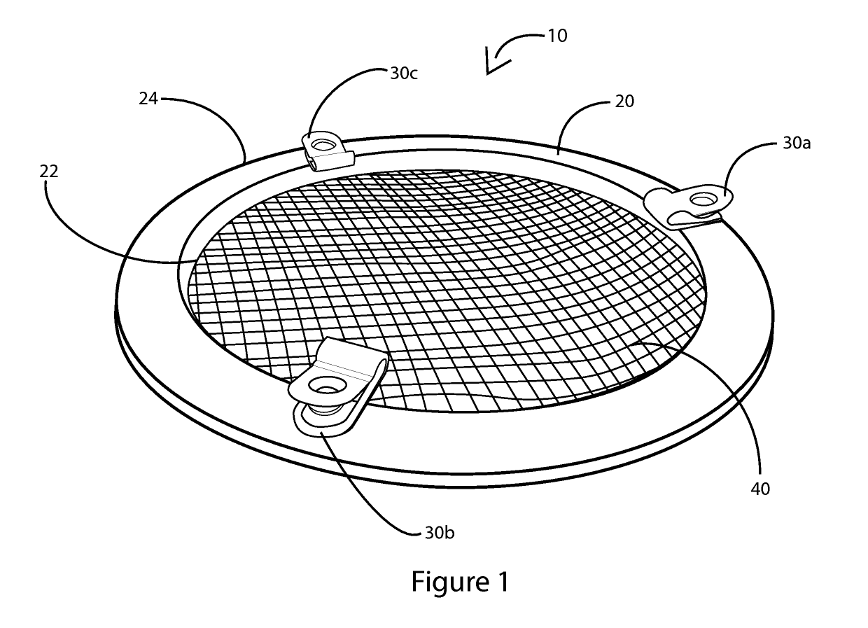

Referring to FIG. 1, an exemplary accessory 10 for use with a guitar is shown. The accessory 10 may fit in a guitar's soundhole and prevent items such as guitar picks from falling into the guitar's body through the soundhole. The accessory 10 may include a body portion 20 attached to one or more fasteners 30a-c. In some embodiments, such as the embodiment shown in FIG. 1, the accessory 10 may include a first fastener 30a, a second fastener 30b, and a third fastener 30c. The accessory 10 may include a mesh portion 40.

The body portion 20 may be dimensioned so as to prevent items such as guitar picks from falling into the soundhole of an instruments. The body portion 20 may be adapted to fit under the soundhole, on top of the soundhole, inside the soundhole, or any combination thereof. The body portion 20 may be substantially the same size and shape as an instrument's soundhole, or it may be larger or smaller than the the soundhole or may be shaped differently than the soundhole. In some embodiments, the body portion 20 is ring-shaped. Other shapes also may be used.

In the illustrated embodiment, the body portion 20 is a rectangular toroid including an inner perimeter 22 and an outer perimeter 24. The diameters of the inner perimeter 22 and the outer perimeter 24 may vary in length. In the illustrated embodiment, the fasteners 30a-c are disposed about the inner perimeter 22. In such an embodiment, the inner diameter 22 is dimensioned so that the fasteners 30a-c may simultaneously engage the guitar's soundhole, such as soundholes that are about three and one-half inches, about three and five-eighths inches, about three and seven-eighths inches, about 4 inches, and the like. Accordingly, the diameter of the inner perimeter 22 may vary with the size and/or placement of the fasteners. In various embodiments, the diameter of the inner perimeter 22 may be between within about one-eighth inch and about seven-eighths inch of the diameter of the guitar soundhole, between within about one-quarter inch and three-quarter inch of the diameter of the guitar soundhole, between within about three-eighths inch and about five-eighths inch of the diameter of the guitar soundhole, and/or within about one-half inch of the size of the diameter of the diameter of the guitar soundhole. Other lengths may also be used. For example, in the illustrated embodiment, the diameter of the inner perimeter 22 may be about four and seven-sixteenths inches for use in a guitar having a four inch soundhole.

The diameter of the outer perimeter 24 may be between within about three-eighths inches and one inch larger than the diameter of the inner perimeter 22. Preferably, the outer diameter 24 is between within about seven-sixteenths inches and about nine-sixteenths inches longer than the diameter of the inner perimeter 22. Other lengths may also be used. In the illustrated embodiment, the diameter of the outer perimeter may be about four and seven-eights inches for use in a guitar with a four inch soundhole.

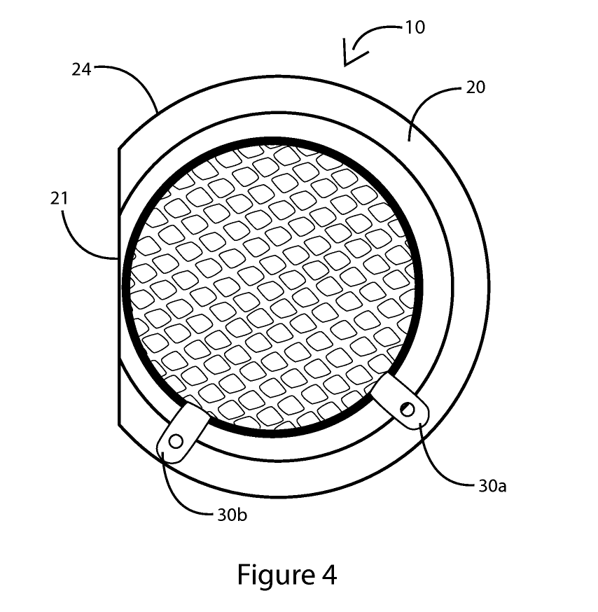

The body portion 20 may be made of any suitable material. In some embodiment, the body portion 20 may be made of a rigid material such as acrylic, carbonite, or the like. In other embodiments, the body portion 20 may be made of a semi-rigid, flexible material such as rubber or the like. Other materials may also be used. For embodiments that secure underneath the soundhole of the instrument, the body portion 20 preferably is made of at least some flexible material. The use of a flexible material eases the installation of the accessory 10 because a guitar player may bend the accessory 10 when inserting it into the soundhole of the instrument. Rigid or flexible materials, or combination of both, may be used for embodiments that secure to the top of the soundhole, such as that described below in reference to FIGS. 4-6.

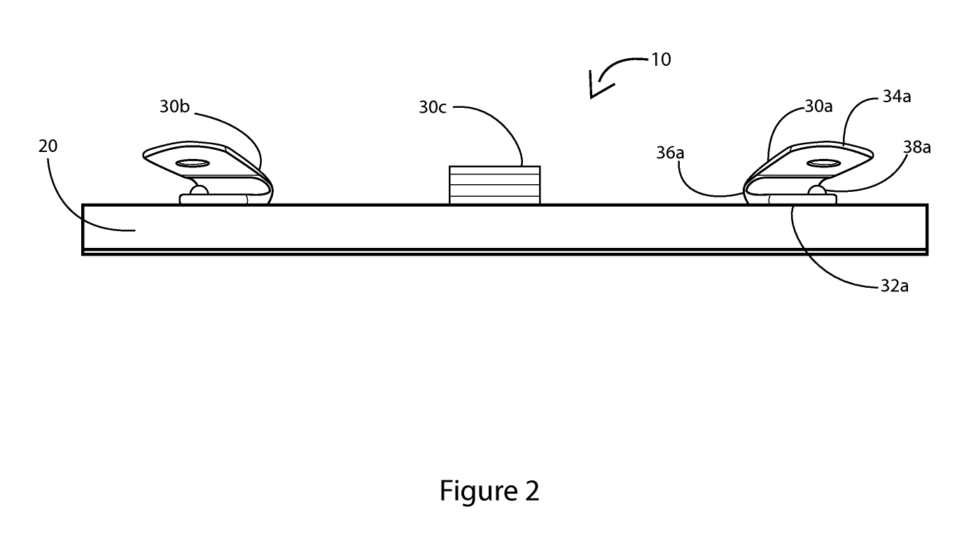

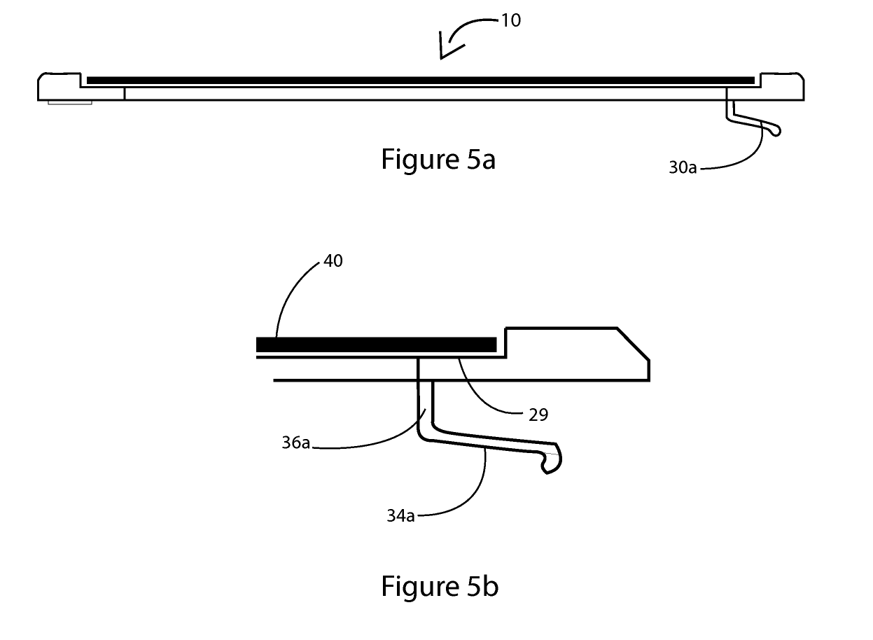

The thickness of the body portion 20 may vary depending on a variety of factors. For example, in embodiments that secure to the top of the soundhole, a thin body portion 20 may be desirable so that the accessory 10 does not contact the strings of the guitar during a performance. For example, a thickness between about one-eighth inch and three-eighths inch may be used in some such embodiments. In the embodiment shown in FIGS. 5a and 5b, the body portion 20 may be about one-eighth inch thick. For embodiments that rest under the soundhole of the guitar (i.e. inside the cavity of the guitar), the thickness of the body portion may be less important. In some such embodiments, the thickness of the body portion 20 may be between about three-sixteenths inch and about one-half inch. In the embodiment shown in FIG. 2, the body portion 20 is about one-quarter inch thick.

To secure the accessory 10 item to the instrument, the accessory 10 may include one or more fasteners 30. In some embodiments, the fasteners 30 are disposed around an inner perimeter 22 of a body portion 20. Alternatively, or additionally, the fasteners 30a-c may be disposed elsewhere on the body portion 20. Referring also to FIGS. 2 and 5, the fasteners 30a-c may be C-shaped clips for securing to the soundhole of the instructions. Other types of fasteners 30a-c also may be used. For example, a fastener 30 may comprise a recess provided in the body portion 20 that engages the perimeter of the soundhole. Fasteners 30a-c may be made of any suitable material. Preferably, fasteners 30a-c are made of soft plastic or vinyl to reduce the possibility of damaging the body of the instrument.

In the embodiment shown in FIGS. 1-3, three fasteners 30a, 30b, and 30c are provided. More or less fasteners may be used. The fasteners 30a-c may be disposed about the inner perimeter 22 of the body portion 20 in Y-shaped pattern in which the fasteners 30a-c are disposed equidistant from one another (i.e. about 120° apart). Other configurations also may be used. For example, two fasteners 30a and 30b may be closer to one another than either is to a third fastener 30c. In some embodiments, two fasteners 30a and 30b are disposed about between about 70° and about 110° apart. In the embodiment shown in FIGS. 5a and 5b, the two fasteners are set off by about 100°.

Referring again to FIG. 1, the mesh portion 40 may be disposed on the body portion 20 so as to cover a gap defined by the inner perimeter 22 of the body portion 20. For example, the mesh portion 40 may be a netting that covers the gap. The mesh portion 40 may be affixed to the body portion 20 by any appropriate means, such as by an adhesive. In some embodiments, the mesh portion 40 and fasteners 30a-c are the only portions of the accessory 10 that cover the soundhole of the instrument. Alternatively, some of the body portion 20 may also cover the instrument's soundhole. The mesh portion 40 may be made of plastic, spandex, or any other suitable material. The mesh portion 40 may be rigid or flexible, or include sub-portions of both rigid and flexible materials. In some embodiments where the body portion 20 is flexible, the mesh portion 40 may also be flexible. In embodiments where the body portion 20 is rigid, the flexibility of the mesh portion 40 may be less important.

FIG. 2 shows a side view of an exemplary guitar accessory 10. As illustrated, the fastener 30a includes a lower arm 32a attached to the body portion 20 and an upper arm 34a for engaging the soundhole. The arms 32a and 34a are connected via a C-shaped spring portion 36a. Optionally, a bumper 38 may be provided to further secure the fastener 30 to the instrument.

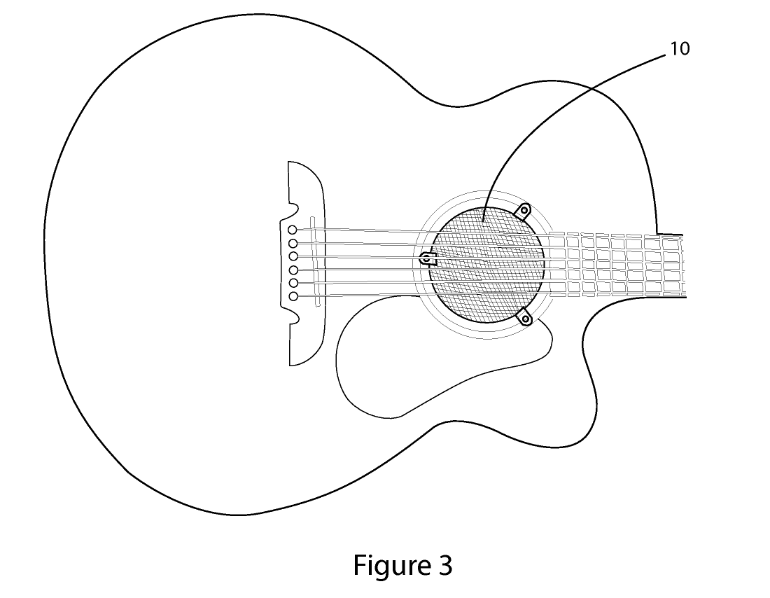

FIG. 3 shows an elevated view of a guitar equipped with an exemplary guitar accessory 10 designed to rest under the soundhole of the guitar. To install the accessory 10, the user may remove the strings of the guitar. Next, the user may bend the accessory 10 and place it through the soundhole with the fasteners 30 facing upward. With the accessory 10 in the guitar body, the user may attach the fasteners 30a-c to the soundhole. For example, the user may attach two fasteners 30a and 30b at the 10:00 and 2:00 positions before attaching the last fastener 30c at the 6:00 position. Once in place, the accessory 10 prevents items such as guitar picks from falling into the guitar cavity without suppressing the sound of the guitar.

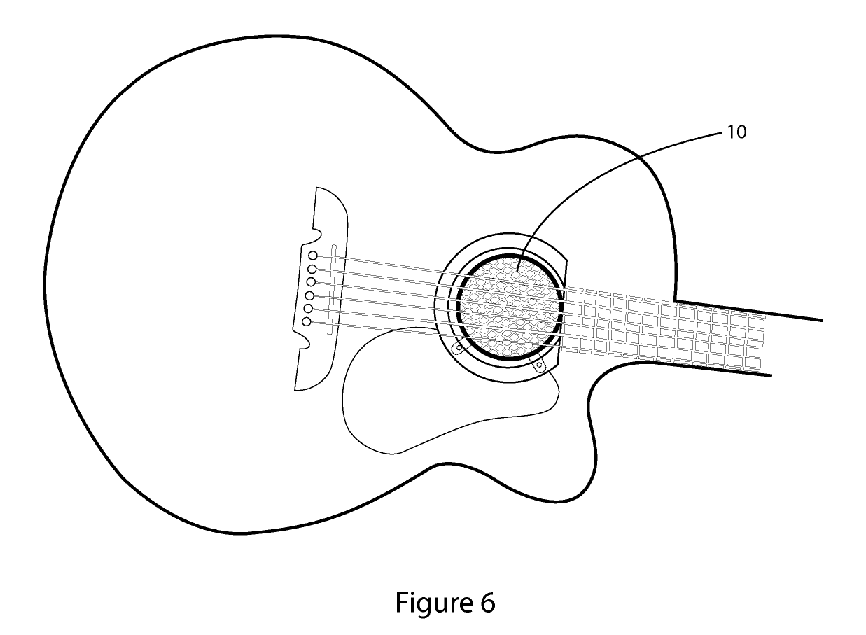

FIG. 4 shows an elevated view of another guitar accessory 10 that sits on top of the guitar body. In the illustrated embodiment, the body portion 20 is made of a clear, rigid plastic. In addition, because the illustrated embodiment is adapted to sit on top of the guitar body, the body portion 20 of the accessory 10 includes a side portion 21 that is adapted to rest next the neck of the guitar. This configuration is shown in more detail in FIG. 6. Other similar adaptations that may be necessitated or desirably in light of the particular components of any particular instrument will be apparent to one of ordinary skill in the art.

FIGS. 5a and 5b show a side view of the exemplary guitar accessory shown in FIG. 4. As illustrated, the body portion 20 may include a recess portion 29 for receiving a mesh portion 40. Because the illustrated embodiment is adapted to sit on top of the guitar body, it may be desirable to dispose the mesh portion 40 at or below the upper part of the body portion 20 so that the accessory 10 does not contact the strings of the guitar during a performance. In the illustrated embodiment, the recess portion 29 provides a depth of about one-sixteenth inch into a body portion 20 having a thickness about one-eighth inch. Alternatively, no recess 29 may be provided in an accessory 10 adapted to fit on top of the guitar body.

FIG. 6 shows an elevated view of a guitar equipped with the exemplary guitar accessory shown in FIG. 4. To install the accessory 10, the user may or may not remove the strings of the guitar. Next, the user may slide the accessory 10 into place around the soundhole with the fasteners 30 facing downward and align the side portion 21 against the end of the guitar's neck. Once in place, the accessory 10 prevents items such as guitar picks from falling into the guitar cavity without suppressing the sound of the guitar.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

I claim:

1. An accessory for use with an instrument having a soundhole comprising:
a body portion defining a gap;
a plurality of fasteners disposed on the body portion and adapted to engage a perimeter of the soundhole; and
a mesh portion attached to the body portion, the mesh portion covering the gap.

2. The accessory of claim 1, where the body portion is flexible.

3. The accessory of claim 2, where the mesh portion is a flexible.

4. The accessory of claim 3, where the mesh portion is made from a different material than the body portion.

5. The accessory of claim 1, where the fasteners are C-shaped clips.

6. The accessory of claim 1, where the body includes a side portion adapted to accommodate a feature of the instrument.

7. The accessory of claim 6, where the body includes a side portion adapted to accommodate a neck of a guitar.

8. The accessory of claim 1, where the plurality of fasteners includes a first fastener, a second fastener, and a third fastener.

9. The accessory of claim 8, where the first fastener, the second fastener, and the third fastener are disposed substantially equidistantly around a perimeter of the body portion.

10. The accessory of claim 8, where the body portion is ring-shaped and where the first fastener, the second fastener, and the third fastener are disposed substantially equidistantly around an inner perimeter of the ring-shaped body portion.

11. The accessory of claim 1, where the body portion includes a recess portion for receiving at least some of the mesh portion.

12. The accessory of claim 1, where the accessory is adapted to fit within the soundhole of the instrument.

13. The accessory of claim 1, where the accessory is adapted to rest on top of the soundhole of the instrument.

14. An accessory for use with an instrument having a soundhole comprising:
a flexible, ring-shaped body portion having an inner perimeter defining a gap;
a plurality of fasteners disposed on the body portion and adapted to engage a perimeter of the soundhole; and
a flexible mesh portion attached to the ring-shaped body portion, the mesh portion covering the gap.

15. The accessory of claim 14, where the body portion is rubber and the mesh portion is spandex.

16. The accessory of claim 15, where the plurality of fasteners include a first C-shaped clip, a second C-shaped clip and a third C-shaped clip disposed substantially equidistantly around the inner perimeter of the body portion.

17. An accessory for use with an instrument having a soundhole comprising:
a rigid body portion having a circular inner perimeter defining a gap, the body portion having a top surface, a recessed portion, and a side portion adapted to accommodate a feature of the instrument;
a plurality of fasteners disposed on the body portion and adapted to engage a perimeter of the soundhole; and
a rigid mesh portion attached to the body portion, the mesh portion partially disposed in the recessed portion, the mesh portion covering the gap.

18. The accessory of claim 17, where the body portion and the mesh portion are plastic.

19. The accessory of claim 18, where the side portion is adapted to accommodate the neck of a guitar.

20. The accessory of claim 19, where the plurality of fasteners include a first C-shaped clip and a second C-shaped clip disposed about 100° apart around the inner perimeter of the body portion.
